(19) United States
(12) Patent Application Publication
(10) Pub. No.: US 2024/0268286 A1
(43) Pub. Date: Aug. 15, 2024

(54) CROP INPUT APPLICATION APPARATUS, SYSTEMS AND METHODS

(71) Applicant: MA Industries, LLC, Morton, IL (US)

(72) Inventors: Greggory Sauder, Morton, IL (US); Timothy Sauder, Morton, IL (US); Justin Koch, Morton, IL (US); Nowell Moore, Morton, IL (US); Reid Aberle, Morton, IL (US); Tyler Nafzinger, Morton, IL (US); Connor Hesterberg, Morton, IL (US); Jonathan Welte, Morton, IL (US); Kyle Waremburg, Morton, IL (US); Steven Nuest, Morton, IL (US)

(21) Appl. No.: 18/652,489

(22) Filed: May 1, 2024

Related U.S. Application Data
(63) Continuation of application No. PCT/US21/72159, filed on Nov. 1, 2021.
(63) Continuation of application No. PCT/US2021/072169, filed on Nov. 1, 2021.
(60) Provisional application No. 63/260,444, filed on Aug. 19, 2021.
(60) Provisional application No. 63/149,644, filed on Feb. 15, 2021.
(60) Provisional application No. 63/138,222, filed on Jan. 15, 2021.
(60) Provisional application No. 63/107,608, filed on Oct. 30, 2020.

(51) Int. Cl. A01G 25/16; A01G 25/09

(52) U.S. Cl. CPC A01G 25/16; A01G 25/09

(57) ABSTRACT

An irrigation vehicle supports a reel and a flexible conduit positioned on the reel. A conduit control assembly controls dispensing and retraction of the flexible conduit from and to the reel. The conduit control assembly can include a conduit tension sensing assembly, a conduit angle sensing assembly and a frame supporting a gripping assembly.

### BACKGROUND

This disclosure relates to application of crop input and use of vehicles for application of crop input. The vehicle supports a reel and flexible conduit that can be extended from or retracted onto said reel.

### BRIEF DESCRIPTION OF DRAWINGS

FIG. 1 is a front perspective view of an application vehicle.

FIG. 2 is a rear perspective view of the application vehicle of FIG. 1.

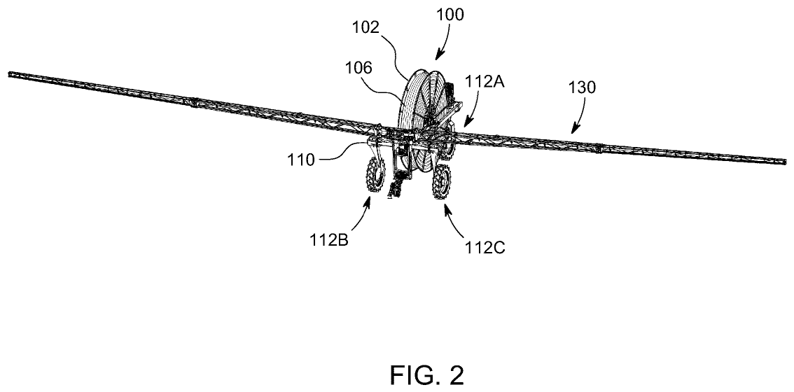

FIG. 3 is a right-side view of the application vehicle of FIG. 1.

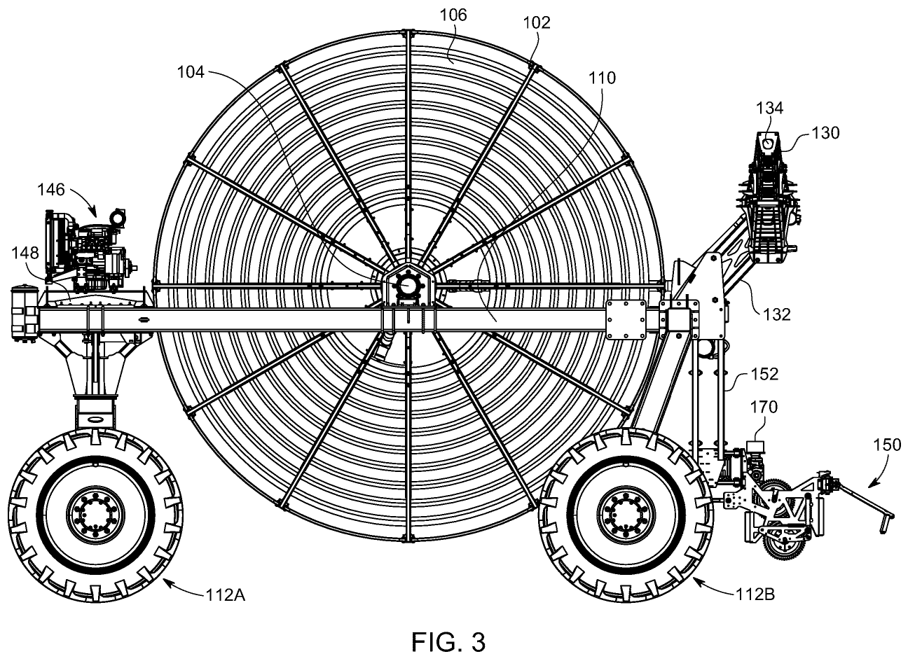

FIG. 4 is a left-side view of the application vehicle of FIG. 1.

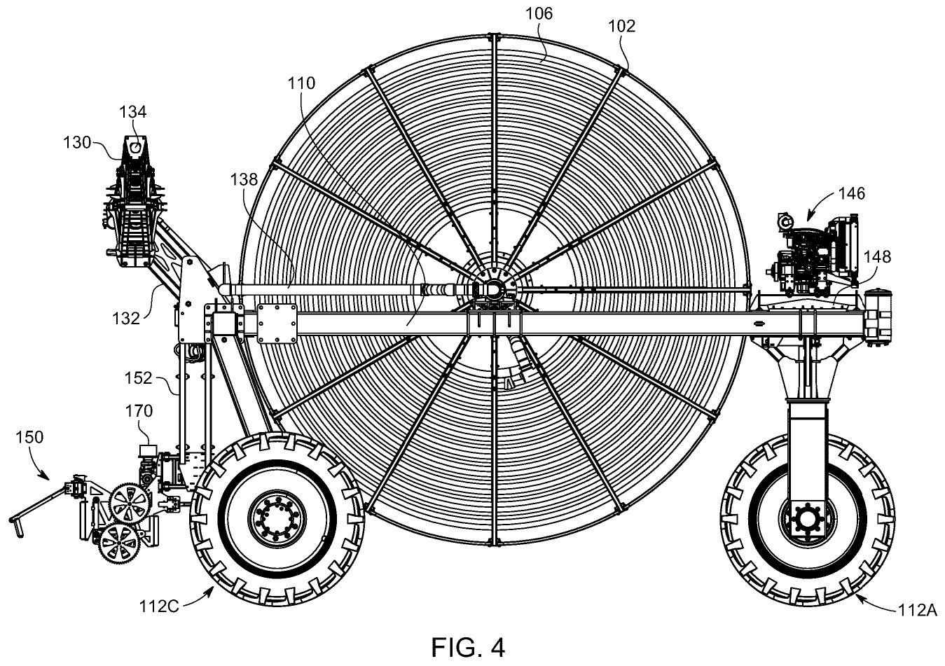

FIG. 5 is a front view of the application vehicle of FIG. 1.

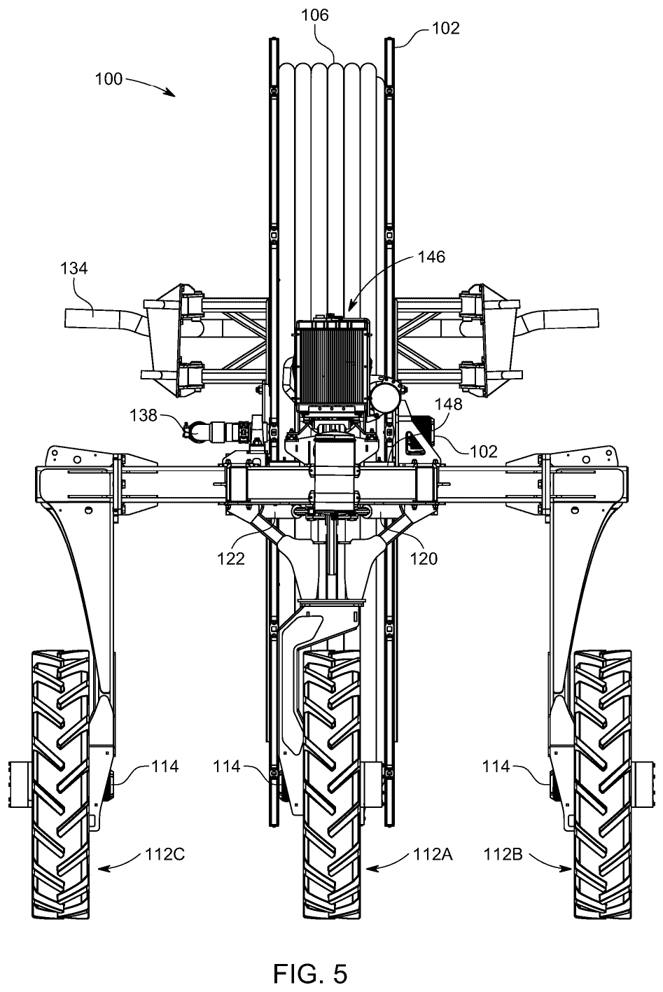

FIG. 6 is a rear view of the application vehicle of FIG. 1 with a boom removed.

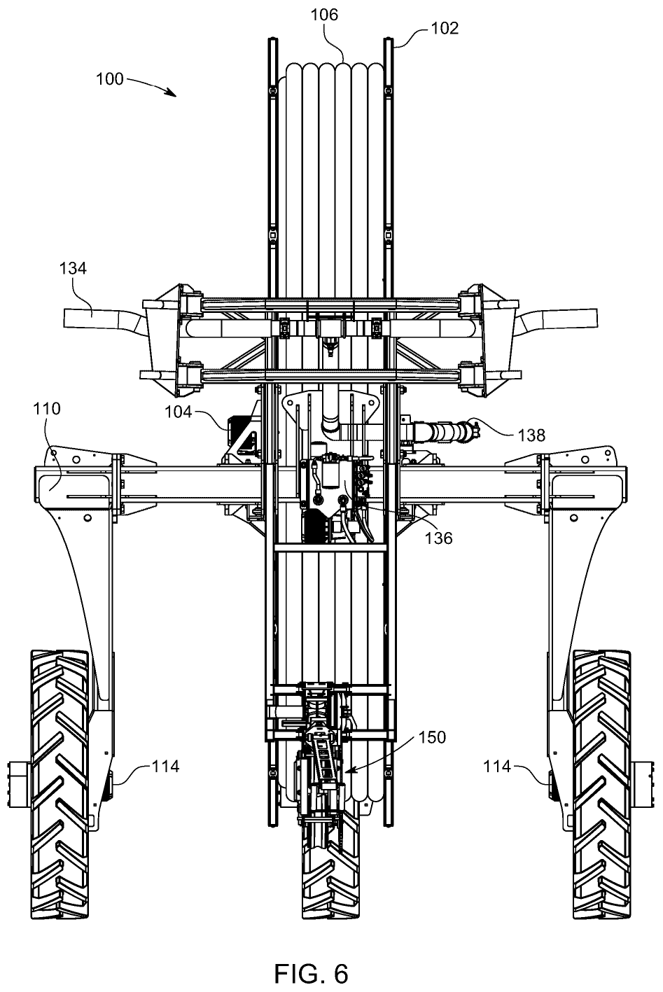

FIG. 7 is a top view of the application vehicle of FIG. 1 with a boom removed.

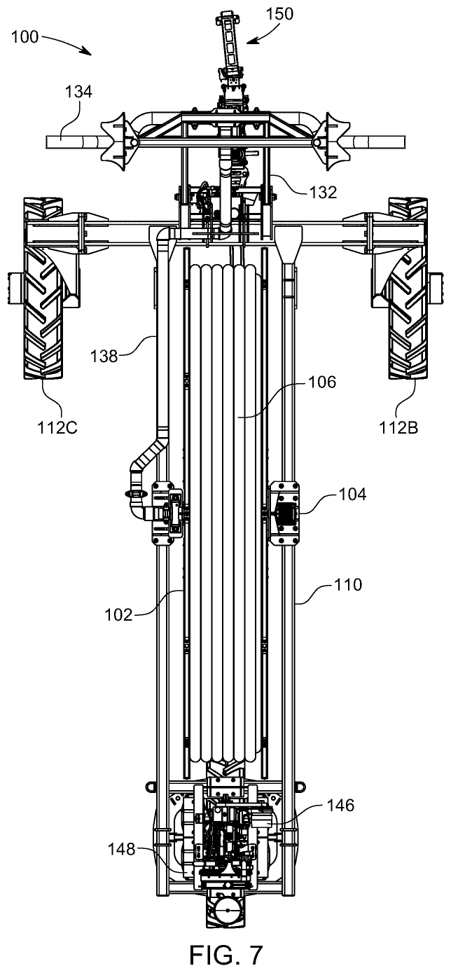

FIG. 8 is a bottom view of the application vehicle of FIG. 1 with a boom removed.

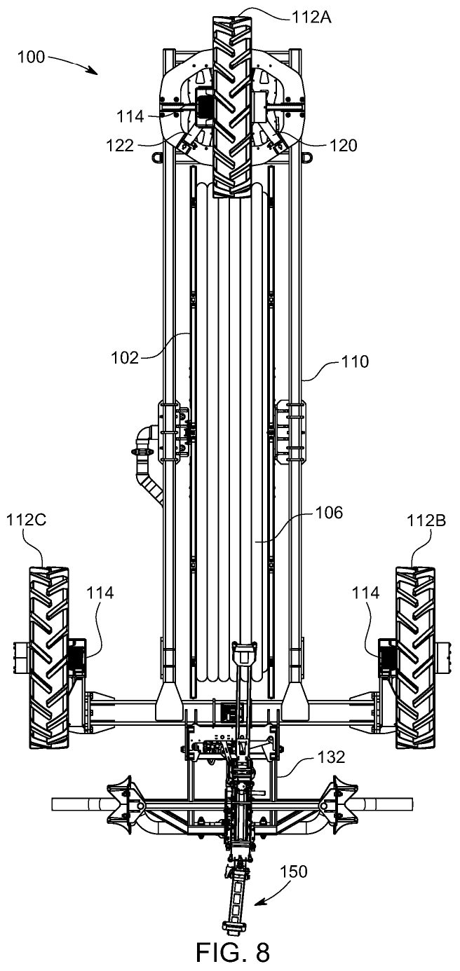

FIG. 9 is a front perspective view of a conduit dispensing assembly.

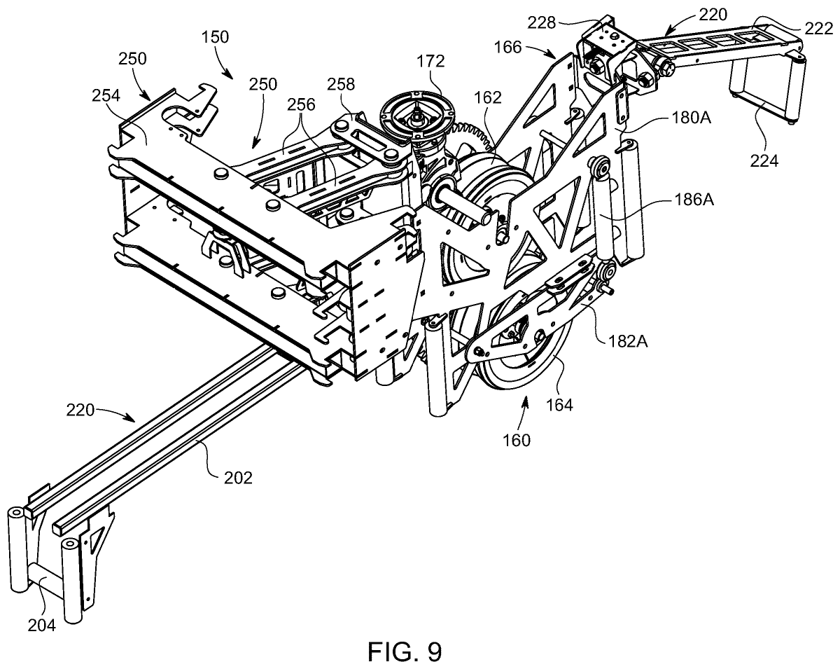

FIG. 10 is a rear perspective view of the conduit dispensing assembly of FIG. 9.

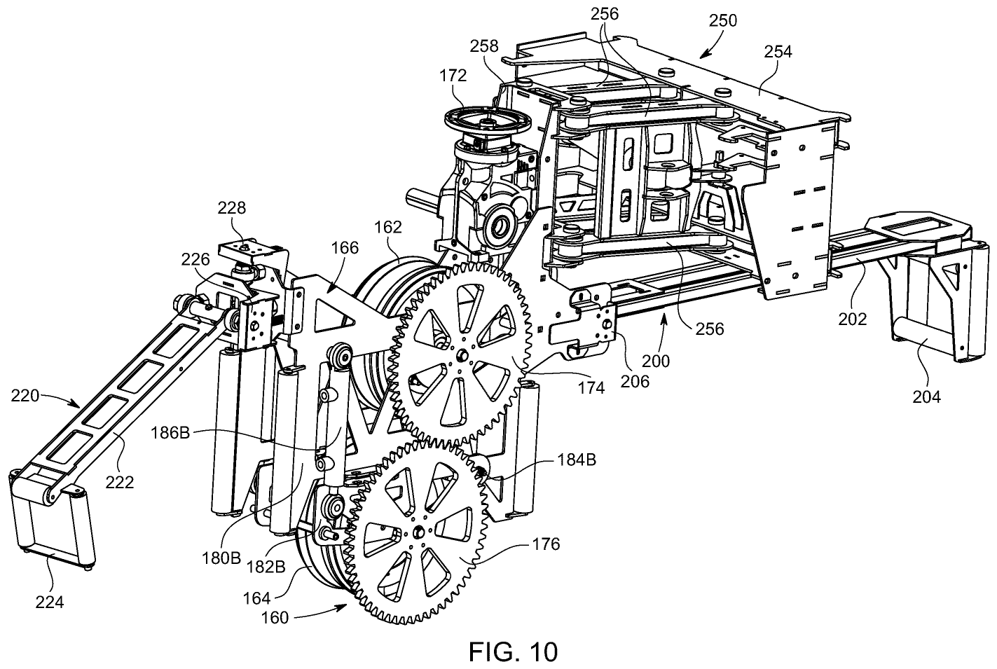

FIG. 11 is a right-side view of the conduit dispensing assembly of FIG. 9.

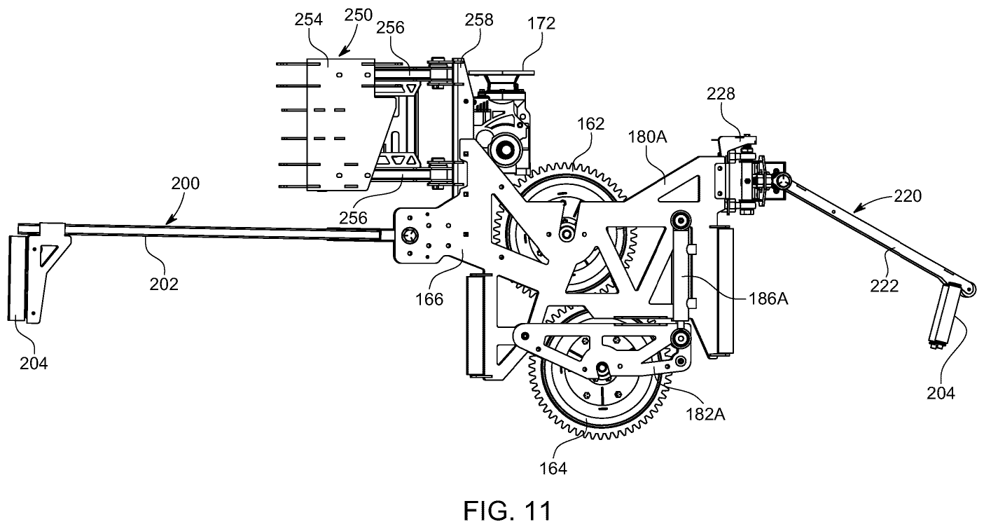

FIG. 12 is a left-side view of the conduit dispensing assembly of FIG. 9.

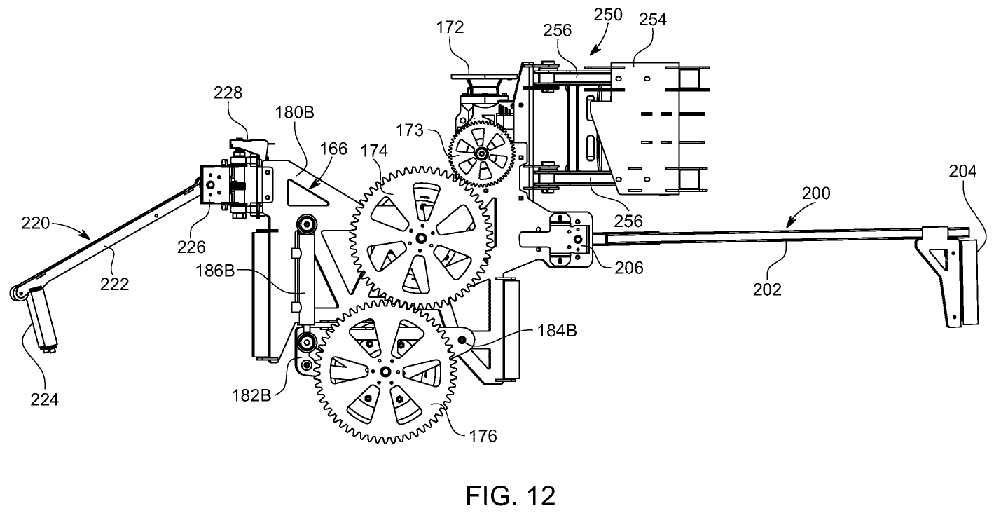

FIG. 13 is a top view of the conduit dispensing assembly of FIG. 9.

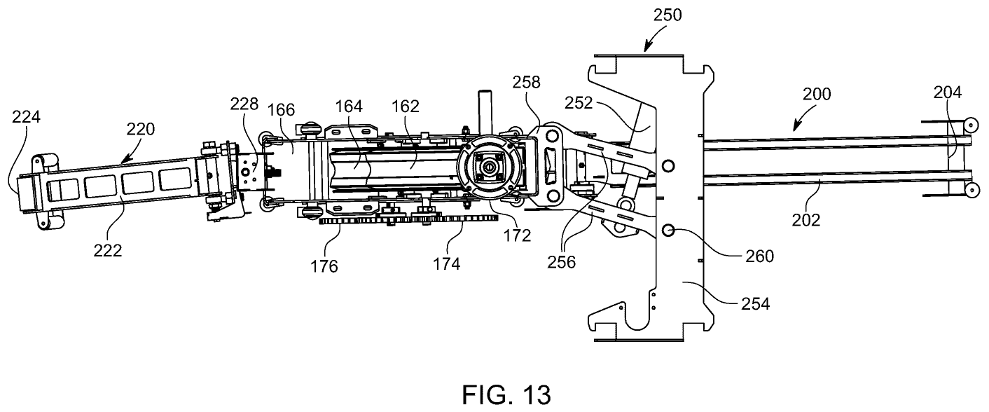

### DETAILED DESCRIPTION

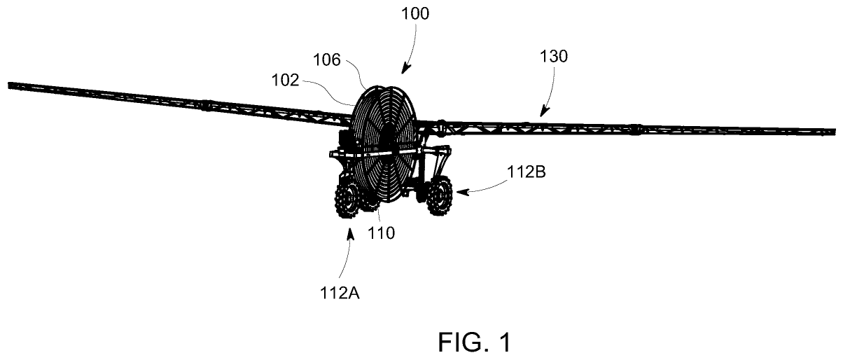

It will be appreciated that different embodiments employing one or more features of crop input applicator vehicles are described herein. Features discussed with respect to one embodiment can be applied to other embodiments as desired. Referring now to the drawing figures wherein like reference numerals designate the same or corresponding components throughout the several figures, FIG. 1 illustrates one embodiment of a crop input applicator vehicle 100 including a reel 102 rotationally supported on a central shaft that is connected with a motor 104. In one embodiment, the central shaft is connected with the motor 104 through a planetary gear. The reel 102 supports a flexible conduit 106. The vehicle 100 includes a frame 110 supported on a plurality of wheel assemblies 112, including a front wheel assembly 112A and rear wheel assemblies 112B and 112C. Front wheel assembly 112A is steerable with respect to the frame 110 to navigate the vehicle 100 through a field of crops (e.g., a row crop). Wheel assemblies 112, in one embodiment, are powered by electric motors 114 that enable vehicle 100 to propel throughout the field. In some embodiments, an actuator assembly 118 is configured to steer the wheel assembly 112, e.g., to pivot a wheel portion relative to the frame 110. In the illustrated embodiment, actuator assembly 118 includes opposed hydraulic actuators 120 and 122.

Extending from a rearward portion of the frame 110 is a boom 130 mounted on a linkage 132 supported by the frame 110. According to various embodiments, the boom 120 can be of any number of different lengths and of any number of different configurations. For example, common boom 120 lengths include 40 feet, 60 feet, 80 feet, and 120 feet. Any other boom 120 length could be employed, as well, in accordance with different embodiments. In different embodiments, the boom 120 can be attached in front of frame 110 or behind the frame 110.

The boom 120 supports a conduit 134 extending generally transversely across the vehicle 100 and further can support a plurality of applicators. In one embodiment, the applicators include drop assemblies fluidly coupled with the conduit 134. A pump and valve assembly 136 (e.g., including an electric motor and valves) control the flow rate of fluid (e.g., crop input) to one or more selected applicators. A conduit 138 is positioned to carry fluid from conduit 106 to the conduit 134.

A power unit 146 and master controller assembly 148 can be carried by frame 110 to provide power to one or more power-consuming devices (e.g., motors, pumps, processors) of vehicle 100. In one embodiment, the power unit 146 includes a diesel generator and one or more batteries to store and/or deliver power to devices on the vehicle. In other embodiments, the power unit is another power source such as a battery pack or remote power source connected with vehicle 100. Master controller 148 is connected to various components on vehicle 100 to provide control of the vehicle (e.g., application of liquid through drop assemblies, navigation of vehicle 100).

Vehicle 100 further includes a conduit control assembly 150 that controls dispensing and retraction of flexible conduit 106 relative to the ground. In one embodiment, the conduit control assembly 150 is connected to frame 110 through a bracket 152. In the illustrated embodiment, conduit control assembly 150 is positioned at a rear of vehicle 100. In other embodiments, the conduit control assembly 150 can be positioned at a front or in an intermediate position of the vehicle 100. During operation, motor 104 cooperates with conduit control assembly 150 to dispense and retract conduit 106 from and to the reel 102. Conduit control assembly 150, as discussed herein, can include one or more sensors to calculate a position of the conduit 106. In one embodiment, these sensors include angle sensors such as PST-360G2 available from Amphenol Corporation of Wallingford, Connecticut. Angle sensors can utilize a Hall effect sensor to identify a position of a shaft relative to an opening.

Conduit control assembly 150 includes a gripping assembly 160 to frictionally engage conduit 106. In the illustrated embodiment, gripping assembly 160 includes first and second gripping devices 162 and 164. In an alternative embodiment, gripping assembly 160 includes a single gripping device that frictionally engages the conduit 106. The gripping devices 162 and 164 herein are rollers, but can be other devices such as tires, tracks or other gripping devices. A frame 166 rotationally supports the gripping devices 162 and 164. In one embodiment, one or more of the gripping devices 162 and 164 can be driven by a motor 170 or other actuator. In the illustrated embodiment, motor 170 is connected to a gearbox 172, which in turn is connected through a spur gear 173 to a spur gear 174 connected to the frame 166 and rotationally connected with gripping device 162. Spur gear 174 is directly connected with spur gear 176, which is rotationally connected with gripping device 164. Gripping device 162 and gripping device 164 rotate in opposite directions upon operation of motor 170. The gripping devices 162 and 164 can be turned at a speed such that the conduit 106 is dispensed off or returned onto the reel 102 at a speed equal and opposite to the ground speed of the vehicle 100.

A distance between the gripping devices 162 and 164 can be a fixed distance or adjustable by an actuator or other mechanism (e.g., a spring) to maintain a gripping force by the gripping devices 162 and 164 onto the conduit 106. In the illustrated embodiment, frame 166 includes upper plates 180A and 180B connected to either side of gripping device 162. Additionally, frame 166 includes lower plates 182A and 182B connected to either side of the gripping device 164. Lower plate 182A is pivotally connected to upper plate 180A about a connection 184A. Additionally, a hydraulic cylinder 186A connects the lower plate 182A and upper plate 180A. As lower plate 182A pivots about connection 184A, cylinder 186A operates to maintain gripping pressure between griping devices 162 and 164. Similarly, lower plate 182B is pivotally connected to upper plate 180B about a connection 184B. Additionally, a hydraulic cylinder 186B connects the lower plate 182B and upper plate 180B. As lower plate 182B pivots about connection 184B, cylinder 186B operates to maintain gripping pressure between griping devices 162 and 164. In a further embodiment, hydraulic cylinders 186A and 186B can be operated to master controller 148 to adjust the position of plates 182A and 182B relative to upper plates 180A and 180B, respectively, thereby adjusting a gripping pressure between gripping devices 162 and 164.

A conduit tension sensing assembly 200 can be positioned between the frame 166 and the reel 102 to measure tension of the conduit 106 as the conduit 106 leaves or returns to the reel 102. Conduit tension sensing assembly 200 includes an elongate member 202 connected with the frame 166 and a support member 204 to support the conduit 106. A sensor 206 measures an angle of the elongate member 202 with respect to the frame 166 to calculate a tension of the conduit 106.

Gripping devices 162 and 164, in one embodiment, can be positioned to bias the conduit 106 higher or lower as the conduit 106 passes through frame 166. In one embodiment, gripping device 162 is positioned more forward relative to gripping device 164. This arrangement will bias any slack in the conduit 106 to be forced into the support member 204 to assist in obtaining a tension measurement. In one embodiment, output from sensor 206 is calculated with respect to a target set point. The target set point can be established based on a wrap layer (e.g., a position of the conduit along a width of the reel) of the conduit 106. If sensor 206 is outside of a range of the target set point, reel speed can be adjusted.

A conduit angle sensing assembly 220 can be positioned between the frame 166 and ground to measure angles of the conduit 106 as the conduit 106 leaves and returns to the reel 102. Conduit angle sensing assembly 220 includes an elongate member 222 and a support member 224. Conduit 106 is positioned within the support member 224. A vertical angle sensor 226 measures an angle of elongate member 222 about an axis parallel to the ground. Additionally, a horizontal angle sensor 228 measures an angle of elongate member 222 about an axis perpendicular to the ground.

Vertical conduit angle sensor 226 detects changes in the shape of the conduit as it leaves the frame 166. If too much conduit is being dispensed relative to the ground speed of the vehicle, the conduit will tend to rise higher off the ground and lift the elongate member 222. The speed of the gripping devices 162 and 164 can then be lowered to reduce the amount of conduit dispensed and allow the vertical angle sensor 226 to return to a selected target position. Likewise, if too little conduit is being dispensed relative to the ground speed of the vehicle, the conduit will drop towards the ground and pull the elongate member 222 down. The speed of the gripping devices 162 and 164 can then be increased to speed up the amount of conduit being dispensed such that the vertical angle sensor 226 returns to the selected target position.

During operation, a speed (i.e., displacement per unit of time) of the gripping devices 162 and 164 can be adjusted based on measurement from horizontal angle sensor 228 to account for errors that would result in an incorrect length of conduit leaving or returning to the reel 102. In one embodiment, the speed of the conduit passing through the frame 166 is adjusted to keep the horizontal angle sensor 228 positioned straight relative to the frame 166. In another embodiment, the speed of the conduit is adjusted to align the horizontal angle sensor 228 with a direction of travel of the vehicle 100 as it moves. In one example as the vehicle turns through a curve, too little conduit may be dispensed. The horizontal angle sensor 228 will be pulled towards the inside of the curve by the conduit. The speed of the gripping devices 162 and 164 can then be increased to dispense more conduit and thereby push the horizontal angle sensor 228 back to a selected target position. Likewise, if too much conduit is being dispensed, the conduit will push the horizontal angle sensor 228 away from the inside of the curve. The speed of the gripping devices 162 and 164 can then be reduced to dispense less conduit and allow the horizontal angle sensor to return to the selected target position.

The conduit control assembly 150 can further be mounted to a traverser 250 positioned to move the conduit 106 side to side (i.e., laterally) relative to the reel 102 as it passes through the frame 166. As conduit 106 is retracted onto the reel 102, the traverser 250 is moved by an actuator 252 (herein illustrated as a linear hydraulic cylinder) to position the conduit 106 next to the previous wrap created on the reel 102. Traverser 250 includes a bracket 254 that is directly coupled with bracket 152. Connected with the bracket 254 are linkage arms 256 coupled with the actuator 252. Linkage arms 256 are further connected to a vertical bracket 258 that is directly coupled with frame 166. Linkage arms 256 are connected to pivot with respect to the bracket 254 and the vertical bracket 258 such that actuator can pivot linkage arms 256, which in turn positions frame 166. This arrangement allows conduit 106 to be efficiently stored on the reel 102 in sequential wraps. A traverser sensor 260 may be used to monitor the position of the traverser. As conduit is removed from the reel 102, the traverser 250 can be positioned to align with the wrap being unwound at that time, or be positioned in a center of the reel 102 and allow the conduit 106 to flex from where the conduit 106 was wrapped on the reel 102 to pass through the frame 166.

Features of conduit control assembly 150 can be changed in various other embodiments. For example, a linear actuator can be used in place of gripping devices 162 and 164. In this embodiment, two or more gripping arms can be mounted on the end of the linear actuator and positioned to selectively grip the conduit 106. In order to dispense conduit 106, the linear actuator retracts with the gripping arms spread apart. The gripping arms are then closed on the conduit 106 and the linear actuator pushed forward to dispense conduit 106 at a speed equal and opposite of the direction of travel of the vehicle. Sensors described herein may also be used to adjust the speed of the reel 102 or linear actuator to ensure the correct amount of conduit 106 is dispensed from or returned to the vehicle 100.

In other embodiments, the conduit control assembly 150 can be mounted at the front of the vehicle 100 and dispense conduit from the reel 102 such that it tends to intersect the ground beneath the vehicle 100. In this embodiment, conduit tension sensor 200, or other forms of sensors such as an angle sensor, ultrasonic sensor, camera or other contact or non-contact sensor capable of measuring conduit tension may be positioned between the frame 166 and the reel 102 and the reel speed may be adjusted to maintain the conduit tension sensor 200 at a target tension.

In a further embodiment, conduit control assembly 150 can include a ground intersection sensor such as a contact arm with an angle sensor, a camera, ultrasonic, radar, or other contact or non-contact sensor positioned to measure a location where the conduit 106 first contacts or leaves the ground as the vehicle 100 dispenses or retracts conduit. The speed of the gripping devices 162 and 164 can be adjusted to maintain the consistent position where the conduit 106 first contacts or leaves the ground ensuring the correct amount of conduit is dispensed or retracted relative to the speed of the vehicle. One or more additional ground intersection sensors may be used along the remaining length of the vehicle 100 to confirm that the conduit 106 remains in the correct position on the ground.

In another embodiment a control arm extended from the conduit control assembly 150 and force is applied through the arm with a linear, rotary, or other actuator to push the conduit down on the ground so that a reliable first intersection position may be determined by an angle sensor positioned on the arm. Alternatively, or in addition, conduit guides may also be mounted along a length of the vehicle to limit the freedom of the conduit to move on the ground while the vehicle passes over it.

In another embodiment, two control arms can extended from the conduit control assembly 150. A first control arm can apply force to the conduit 106 through an actuator to ensure a measurement by a sensor where the conduit 106 is in contact with the ground and the position of the ground relative to the vehicle. A second control arm can be mounted between the first control arm and the frame 166 to determine the path the conduit takes between the frame 166 and the first control arm by measuring its position with a sensor. The speed of gripping devices 162 and 164 can be adjusted so that the conduit 106 follows a desired path between the frame 166 and the ground ensuring that the amount of conduit dispensed or returned to the vehicle is correct.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A conduit control assembly in an irrigation vehicle having a reel supporting a flexible conduit such that the conduit can be extended from or retracted onto said reel, the conduit control assembly, comprising:
a frame supporting a gripping assembly;
a conduit tension sensing assembly coupled with the frame; and
a conduit angle sensing assembly coupled with the frame.

2. The conduit control assembly of claim 1, wherein the conduit tension assembly includes an elongate member extending from the frame, a support member connected with the elongate member and a sensor, the sensor configured to calculate an angle of the elongate member about an axis with respect to the frame.

3. The conduit control assembly of claim 1, wherein the conduit angle sensing assembly includes an elongate member extending from the frame, a support member connected with the elongate member and a sensor, the sensor configured to calculate an angle of the elongate member about an axis with respect to the frame.

4. The conduit control assembly of claim 3, wherein the axis is horizontal.

5. The conduit control assembly of claim 3, wherein the axis is vertical.

6. The conduit control assembly of claim 1, wherein the conduit angle sensing assembly includes an elongate member extending from the frame, a support member connected with the elongate member, a first sensor and a second sensor, the first sensor configured to calculate a first angle of the elongate member about a first axis with respect to the frame and the second sensor configured to calculate a second angle of the elongate member about a second axis with respect to the frame, the second axis orthogonal to the first axis.

7. The conduit control assembly of claim 1, further comprising a traverser, the traverser including an actuator configured to position the frame laterally with respect to the vehicle.

8. The conduit control assembly of claim 7, wherein the traverser includes linkage arms pivotable with respect to a bracket.

9. The conduit control assembly of claim 1, wherein the gripping assembly includes first and second gripping members supported by the frame.

10. The conduit control assembly of claim 1, wherein the conduit tension assembly is positioned on a first side of the frame and the conduit angle sensing assembly is positioned on a second side of the frame, opposite the first side.

11. A crop input application vehicle, comprising:
a vehicle frame having a reel supporting a flexible conduit such that the conduit can be extended from or retracted onto said reel;
a conduit control assembly, comprising:
a support frame supporting a gripping assembly;
a conduit tension sensing assembly coupled with the support frame; and
a conduit angle sensing assembly coupled with the support frame.

12. The vehicle of claim 11, wherein the conduit tension assembly includes an elongate member extending from the frame, a support member connected with the elongate member and a sensor, the sensor configured to calculate an angle of the elongate member about an axis with respect to the support frame.

13. The vehicle of claim 11, wherein the conduit angle sensing assembly includes an elongate member extending from the support frame, a support member connected with the elongate member and a sensor, the sensor configured to calculate an angle of the elongate member about an axis with respect to the support frame.

14. The vehicle of claim 12, wherein the axis is horizontal.

15. The vehicle of claim 12, wherein the axis is vertical.

16. The vehicle of claim 11, wherein the conduit angle sensing assembly includes an elongate member extending from the support frame, a support member connected with the elongate member, a first sensor and a second sensor, the first sensor configured to calculate a first angle of the elongate member about a first axis with respect to the support frame and the second sensor configured to calculate a second angle of the elongate member about a second axis with respect to the support frame, the second axis orthogonal to the first axis.

17. The vehicle of claim 11, further comprising a traverser, the traverser including an actuator configured to position the support frame laterally with respect to the vehicle frame.

18. The vehicle of claim 16, wherein the traverser includes linkage arms pivotable with respect to a bracket.

19. The vehicle of claim 11, wherein the gripping assembly includes first and second gripping devices having the conduit positioned therebetween.

20. The vehicle of claim 11, wherein the conduit tension assembly is positioned on a first side of the frame and the conduit angle sensing assembly is positioned on a second side of the frame, opposite the first side.
